(19) United States
(12) Patent Application Publication
(10) Pub. No.: US 2007/0022972 A1
(43) Pub. Date: Feb. 1, 2007

(54) Animal Throw Toy and Method

(76) Inventor: Mark D. Morrison, Stamford, CT (US)

Correspondence Address: HAYES, SOLOWAY P.C., 175 CANAL STREET, MANCHESTER, NH, 03101, US

(21) Appl. No.: 11/428,660

(22) Filed: Jul. 5, 2006

Related U.S. Application Data
(63) Continuation-in-part of application No. 11/190,652, filed on Jul. 27, 2005, now abandoned.

(51) Int. Cl. A01K 29/00

(52) U.S. Cl. 119/707

(57) ABSTRACT

A throw device and method of using the same is provided. Generally, the throw device is used to play fetch with an animal. The throw device has a throw object sized to fit within the mouth of the animal, and a handle coupled to the throw object with a cord. A cord retention device has a switch to release the cord coupled between the throw object and the handle.

### CROSS REFERENCE TO RELATED APPLICATION

This application claims priority to copending U.S. Application entitled, “Animal Throw Toy and Method,” having Ser. No. 11/190,652 filed Jul. 27, 2005, which is entirely incorporated herein by reference

### FIELD OF THE INVENTION

The present invention is generally related to animal toys, and more particularly, is related to an adjustable animal throw toy.

### BACKGROUND OF THE INVENTION

Pet owners often play fetch with their pets. The game of fetch consists of tossing an object through the air for retrieval. Typically the object is a ball or some other object that will fit within the mouth of the pet. The pet runs after the tossed object and grabs the object with their mouth. Thereafter, the pet returns the object back to the owner. The owner can continue to play by tossing the object again through the air. The pet repeatedly runs after the object and returns the object to the owner. While playing fetch, the ball or object used to play fetch often becomes covered in pet saliva after a few tosses and returns. This can be unpleasing to many owners.

In addition, the object is thrown with the arm of the owner. This can cause the arm of the owner to become fatigued after repeated tosses. The object also tends to become saturated with pet saliva, which can be both uncomfortable for the owner and is not hygienic. In addition, the ball or object used to play fetch may be limited to the game of fetch. There is a need for a toy that can be used to play multiple games with a pet. In addition, there is a need for a toy that allows for easier throwing and while providing a handle separate from the portion seized by the mouth of the pet.

Thus, a heretofore unaddressed need exists to address the aforementioned deficiencies and inadequacies.

### SUMMARY OF THE INVENTION

Embodiments of the present invention provide an animal throw toy and method of using the same. The throw device includes a throw object with a handle. A cord or rope connects the throw object to the handle. Inside either the throw object or the handle, the cord is connected to the handle via a retracting mechanism. A switch, accessible through either the throw object or the handle, releases or activates the cord retention device pulling the throw object to a resting position against the handle.

The user pulls the throw object away from the handle to the desired length, which may range from zero to about three feet. The user holds onto the handle and swings the throw object in a circular motion. The user releases the handle, allowing the centrifugal force of the swinging throw object to carry the throw object and the handle through the air. The animal retrieves the throw object connected to the handle and returns to the user. The user grasps the handle and instructs the animal to release the throw object. The user can then swing the throw object again, thereby preparing for another toss, or the user can press the switch on the handle and retract the throw object for storage or other play uses.

The throw device provides the user with a handle to grasp. The throw device also allows the user to adjust the length of the cord for varied degrees of tossing power. The user can increase the tossing power by increasing the length of the cord between the throw object and handle, thus providing a faster circular motion of the swinging throw object and a longer toss of the throw device. In one embodiment, the handle is a plush toy having the shape of a cartoon character. In the retracted, resting position the throw object rests against the handle and resembles the nose of the cartoon character. In another embodiment, the switch for activating or releasing the retention device is replaced by a retention device that is activated or released by a rapid pull of the cord or another device known in the art.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1A is a side view of a throw device in a retracted position, in accordance with a first exemplary embodiment of the invention.

FIG. 1B is a side view of the throw device of FIG. 1A in an extended position, in accordance with the first exemplary embodiment of the invention.

FIG. 2 is the throw device of FIG. 1A with a throwing object twirling around a handle, in accordance with the first exemplary embodiment of the invention.

FIG. 3A is a sectional view of the throw device of FIG. 1A showing a cord retention device in a locked position, in accordance with the first exemplary embodiment of the invention.

FIG. 3B is a sectional view of the throw device of FIG. 1A showing the cord retention device in an unlocked position, in accordance with the first exemplary embodiment of the invention.

FIG. 4 is a flow chart illustrating an exemplary method of using the throw device, in accordance with the first exemplary embodiment of the invention.

FIG. 5A is a side view of a throw device in a retracted position, in accordance with a second exemplary embodiment of the invention.

FIG. 5B is a side view of the throw device of FIG. 5A in an extended position, in accordance with the second exemplary embodiment of the invention.

FIG. 6A is a front view of a throw device in a retracted position, in accordance with a third exemplary embodiment of the invention.

FIG. 6B is a side view of the throw device of FIG. 6A in a retracted position, in accordance with the third exemplary embodiment of the invention.

FIG. 6C is a side view of the throw device of FIG. 6A in an extended position, in accordance with the third exemplary embodiment of the invention.

FIG. 7A is a front view of a throw device in a retracted position, in accordance with a fourth exemplary embodiment of the invention.

FIG. 7B is a side view of the throw device of FIG. 7A in a retracted position, in accordance with the fourth exemplary embodiment of the invention.

FIG. 8 is a front cross-sectional view of the throw device of FIG. 7A, in accordance with the fourth exemplary embodiment of the invention.

FIG. 9 is a side cross-sectional view of a portion of the throw device of FIG. 7A, in accordance with the fourth exemplary embodiment of the invention.

FIG. 10A is a front view of an interior portion of the throw device of FIG. 7A, in accordance with the fourth exemplary embodiment of the invention.

FIG. 10B is an additional front view of an interior portion of the throw device of FIG. 7A, in accordance with the fourth exemplary embodiment of the invention.

FIG. 10C is a back view of an interior portion of the throw device of FIG. 7A, in accordance with the fourth exemplary embodiment of the invention.

### DETAILED DESCRIPTION

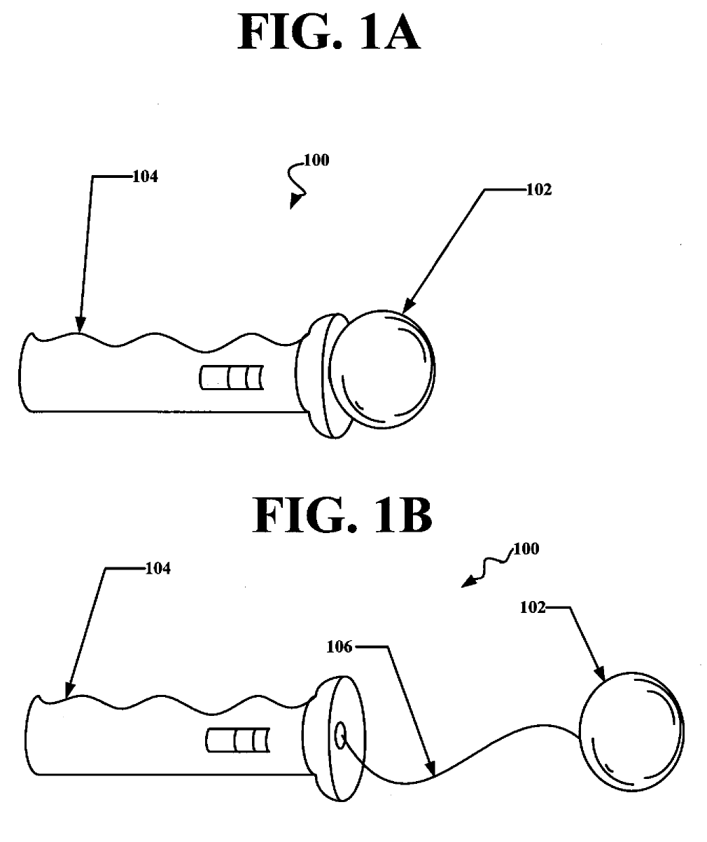

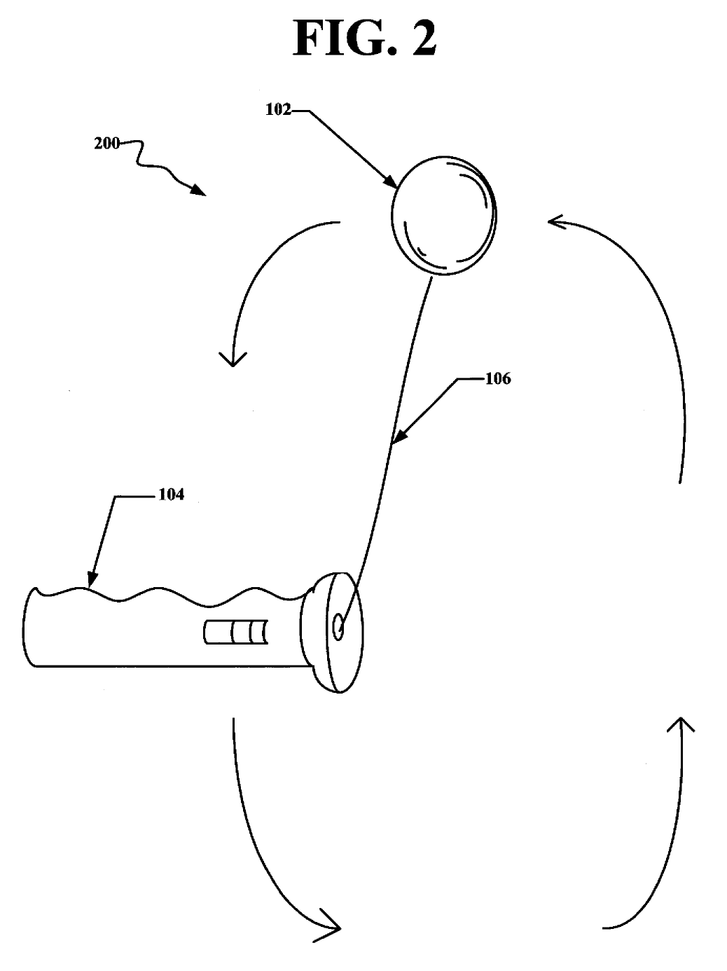

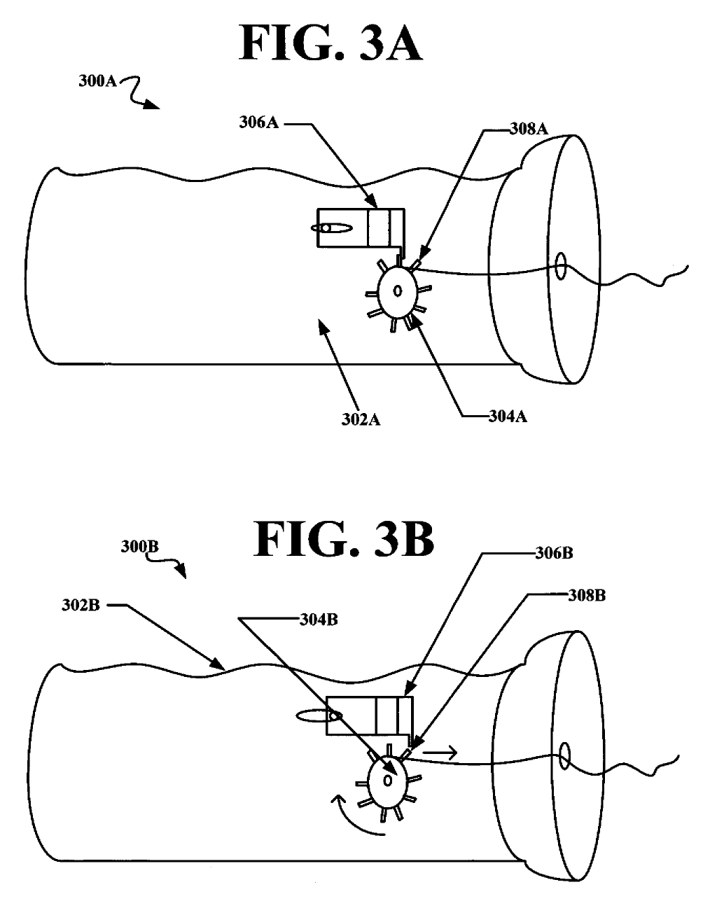

FIG. 1A is a side view of a throw device 100 in a retracted position, in accordance with a first exemplary embodiment of the invention. The throw device 100 has a throw object 102 coupled to a handle 104. The throw object 102 is coupled to the handle 104 with an adjustable length of cord 106 (shown in FIG. 1B). In accordance with the first embodiment, the handle 104 has a cord retention device (shown in FIGS. 3A, 3B) housed within the handle 104. The cord retention device 302A, 302B allows the user to adjust the length of the cord 106, as shown in FIGS. 3A, 3B. FIG. 1B is a side view of the throw device 100 of FIG. 1A in an extended position, in accordance with the first exemplary embodiment of the invention. The length of the cord 106 between the handle 104 and the throw object 102 has been extended. The cord retention device 302A, 302B is described in more detail later herein.

The user utilizes the throw device 100 by extending the cord 106 between the throw object 102 and the handle 104. The user twirls the throw object 102 in a circular manner around the handle 104. FIG. 2 is the throw device 100 of FIG. 1A with a throw object twirling around a handle, in accordance with the first exemplary embodiment of the invention. The throw object 102 circles around the handle 104 when the user moves the hand grasping the handle 104 in a circular motion. Once the throw object 102 has reached the desired rotational speed, the user releases the grip on the handle 104. The centrifugal force of the throw object 102 carries the throw object 102 and handle 104 through the air and away from the user. A pet of the user can run after the throw device 100. The pet grabs the throw object 102 in its mouth. The pet returns the throw device 100 to the user. The user may grab the handle 104 of the throw device 100 and prepare for another toss.

The user can vary the distance that the throw device 100 travels by changing the rotational speed of the wrist of the hand grasping the handle 104 of the throw device 100. By increasing the speed of rotation of the wrist of the user, the user can increase the distance the throw device 100 will travel through the air. Similarly, by decreasing the speed of rotation of the wrist of the user, the user can decrease the distance the throw device 100 will travel through the air.

In addition to changing the rotational speed imparted by the wrist of the user, the user can also increase the distance between the throw object 102 and the handle 104. The user can pull the throw object 102 further apart from the handle 104 and increase the length of the cord 106 coupling the throw object 102 and handle 104. The twirl motion imparted on the handle 104 causes the throw object 102 to rotate at a faster speed. The throw object 102 rotating at the faster speed will travel a farther distance when released by the user. Similarly, the user can decrease the distance between the throw object 102 and the handle 104, thus decreasing the speed of rotation and the distance traveled by the throw device 100 upon release. A swivel mechanism may be incorporated for connecting the cord 106 to the handle 104 such that the cord 106 does not become twisted by the rotation of the cord 106 in relation to the handle 104.

In the first embodiment, the throw object 102 is shown in FIGS. 1A, 1B, and 2 as a ball. However, the throw object 102 can be a variety of shapes and sizes, for example but not limited to, a bone shape, fish shape, or hot dog shape. The throw object 102 can be sized to fit within the mouth of the animal playing fetch. The exterior surface of the throw object 102 can be made of a soft material with a padded surface in order to prevent injury to the animal during fetching. The exterior surface can be made of, for example but not limited to, rubber, foam padding, or micro beads. The weight of the throw object 102 can be designed to produce sufficient momentum to carry both the throw object 102 and the handle 104 through the air to a desired distance range. The desired distance range may vary depending on the size and nature of the animal intended to retrieve the throw device 100.

The exterior surface of the handle 104 can also be made of a soft material, as described above, to prevent injury to the animal during fetching. The weight of the handle 104 can be designed to be less than the weight of the throw object 102. The weight can be light enough to allow the momentum of the throw object 102 to carry the handle 104 and the cord 106 through the air to a desired distance range. In the first embodiment, the handle 104 is shaped to provide easy grip of the user hand, however, the handle 104 can be made in a variety of shapes and sizes. The handle 104 can be designed collectively with the throw object 102 to look like an article, as will be discussed later herein.

FIG. 3A is a sectional view of the throw device 100 of FIG. 1A showing a cord retention device in a locked position, in accordance with the first exemplary embodiment of the invention. In accordance with the first embodiment, the cord retention device 302A has a spring-loaded spool 304A with a locking switch 306A. When the switch 306A is in a locked position, the cogs 308A on the spring-loaded spool 304A are prevented from winding or unwinding the cord 106. In the locked position 300A, as shown in FIG. 1B, the throw object 102 can be twirled and tossed through the air. The throw object 102 and handle 104 can also be used to play tug-of-war with the pet. When playing tug-of-war, the pet pulls on the throw object 102 while the user pulls on the handle 104. In a locked retract position, as shown in FIG. 1A, the throw device 100 can be used as a chew toy by the pet, or the throw device 100 can be compactly stored for later use.

FIG. 3B is a sectional view of the throw device 100 of FIG. 1A showing the cord retention device in an unlocked position, in accordance with the first exemplary embodiment of the invention. The spring-loaded spool 304B is allowed to retract the cord 106 and wind it around the spring-loaded spool 304B. The switch 306B is moved forward into an unlocked position 300B, the cogs 308B on the spring-loaded spool 304B are allowed to rotate and wind or unwind the cord 106. In the unlocked position 300B, the cord 106 is retracted by the spring-loaded spool 304B to wind in the cord 106 and bring the throw object 102 closer to the handle 104. In the unlocked position 300B, the cord 106 can also be unwound from the spring-loaded spool 304B by exerting a force greater than that produced by the spring-loaded spool 304B.

The length of the cord 106 between the handle 104 and the throw object 102 is adjustable. The user may adjust the length of the cord 106 by pulling the throw object 102 and handle 104 apart from each other. The switch 306B may then be moved into the locked position 300A (shown in FIG. 3A) to lock in the adjusted length of the cord 106, which may allow the cord 106 to be any of a plurality of lengths. The user can increase or decrease the length of the cord 106 between the throw object 102 and the handle 104, which, as an example may range from zero to about three feet depending on the desired tossing distance.

The cord retention device 302A, 302B described in accordance with the first embodiment, is just one example of construction of the throw device 100. A variety of other construction methods can be designed and are within the scope of the throw device 100. For example, the cord retention device 302A, 302B can be designed with an internal activated switch (not shown). The spring-loaded spool 304A, 304B can be activated or deactivated by rapidly jerking on the cord 106. The spring-loaded spool 304A, 304B can also be designed to activate when the throw device 100 hits the ground after being tossed. This example of construction allows the object 102 to be in an extended position during the toss and then to retract to the handle 104 prior to the animal fetching the throw device 100. This example of construction prevents the cord 106 and/or object from becoming entangled or stepped on while the animal is returning the throw device 100 to the user. In another example of construction, the cord retention device 302A, 302B can be housed within the throw object 102 instead of the handle 104. A variety of other cord retention devices 302A, 302B and construction methods can be used with the throw device 100 and are within the scope of the invention.

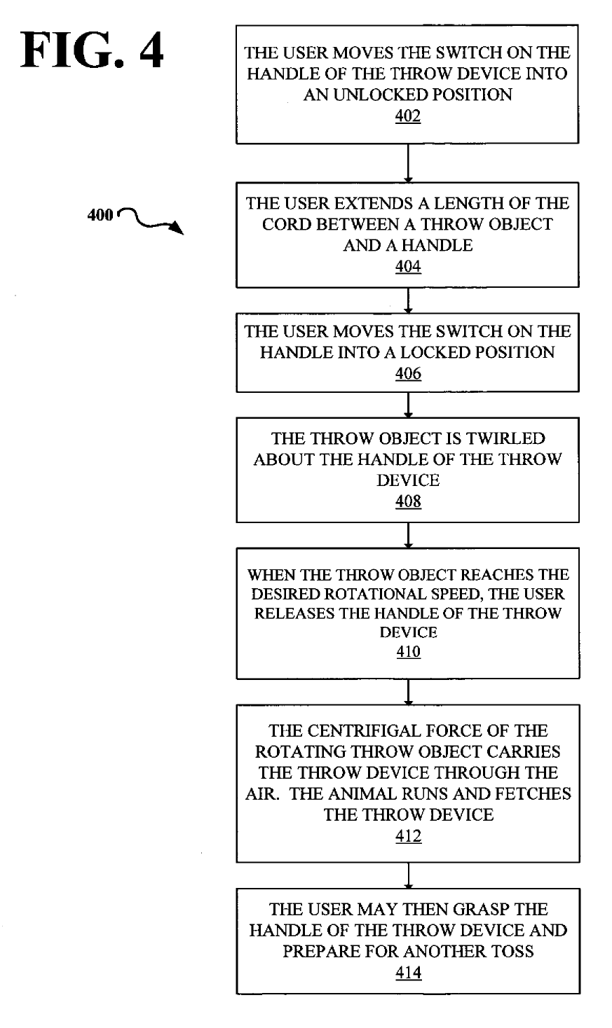

FIG. 4 is a flow chart illustrating an exemplary method of using the throw device 100, in accordance with the first exemplary embodiment of the invention. The user moves the switch on the handle 104 of the throw device 100 into an unlocked position (block 402). The user extends a length of the cord 106 between a throw object 102 and a handle 104 (block 404). This step is accomplished by unwinding the desired length of the cord 106 from the spring-loaded spool 304A, 304B. The user moves the switch 306A on the handle 104 into a locked position 300A (block 406). The throw object 102 is twirled about the handle 104 of the throw device 100 (block 408). When the throw object 102 reaches the desired rotational speed, the user releases the handle 104 of the throw device 100 (block 410). The centrifugal force of the rotating throw object 102 carries the throw device 100 through the air. The animal runs and fetches the throw device 100 (block 412). The user may then grasp the handle 104 of the throw device 100 and prepare for another toss (block 414). In between tosses, the user can adjust the length of the cord 106 by activating and deactivating the cord retention device 302A, 302B. The above method is an exemplary method. Other methods can be used with the throw device 100 depending on the game played with the animal and the cord retention device 302A, 302B incorporated within the throw device 100.

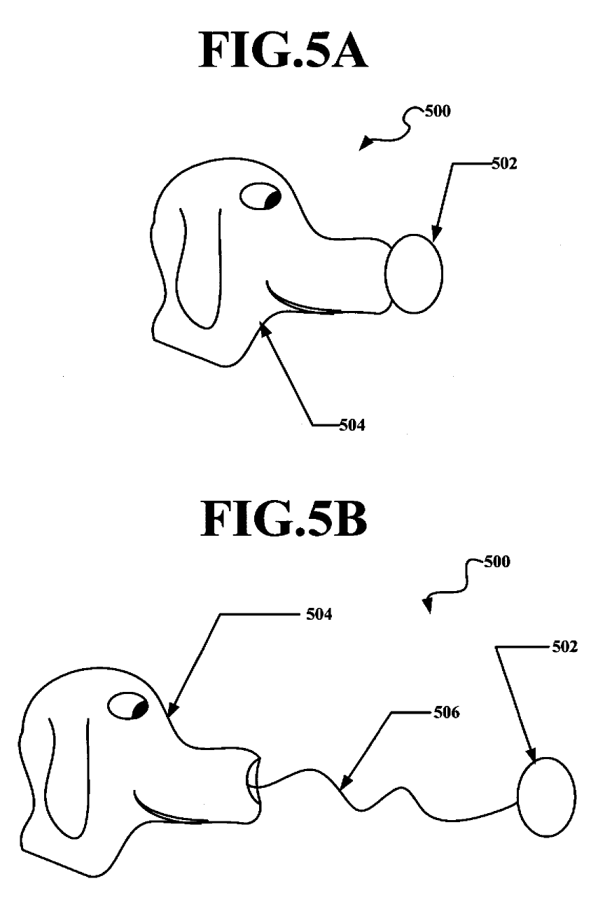

FIG. 5A is a side view of a throw device 500 in a retracted position, in accordance with a second exemplary embodiment of the invention. In accordance with the second embodiment, the throw device 500 is shaped to resemble the head of a dog. The throw object 502 is a ball and is made to resemble the tip of the nose of the dog. The handle 504 is shaped like the rest of the head of the dog. Similar to the throw device 100 described in the first embodiment, the user grasps the dog head-shaped handle 504 and twirls the throw object 502 in a circular manner. The momentum of the throw object 502 carries the dog head-shaped handle 504 through the air. The animal grasps the throw object 502 within its mouth and returns the throw device 500 to the user. A switch (not shown) and a cord retention device (not shown) can be incorporated with the throw device 500 of the second embodiment as described in the first embodiment of the throw device 100. FIG. 5B is a side view of the throw device 500 of FIG. 5A in an extended position, in accordance with the second exemplary embodiment of the invention.

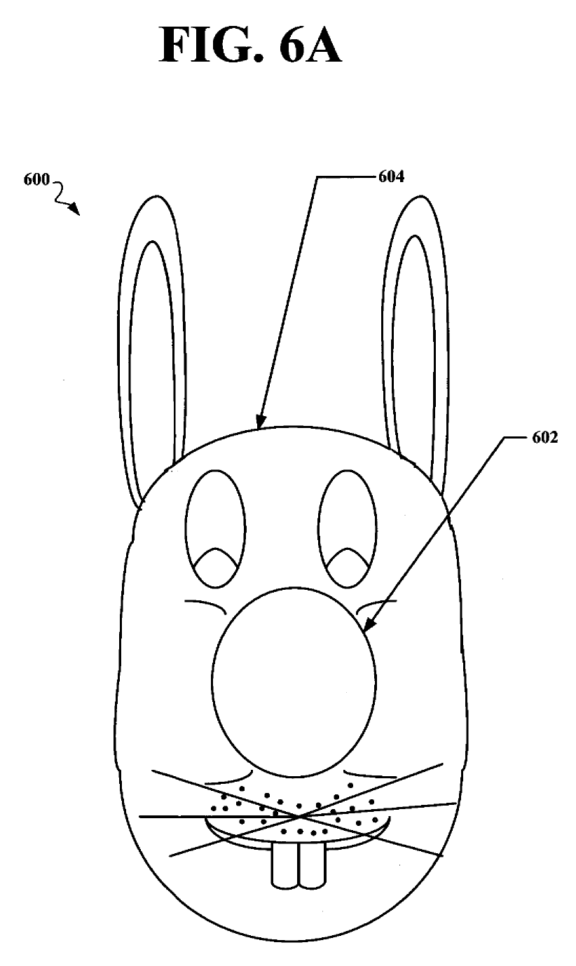

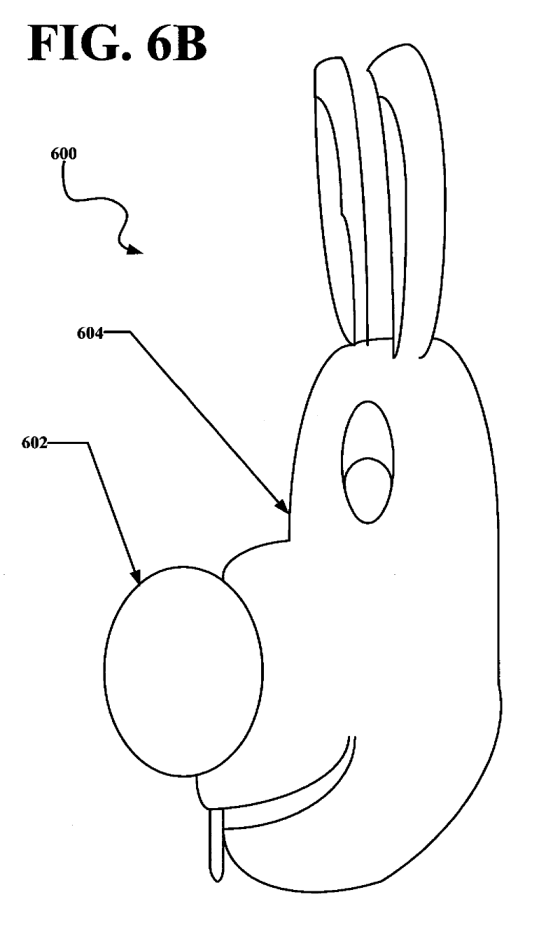

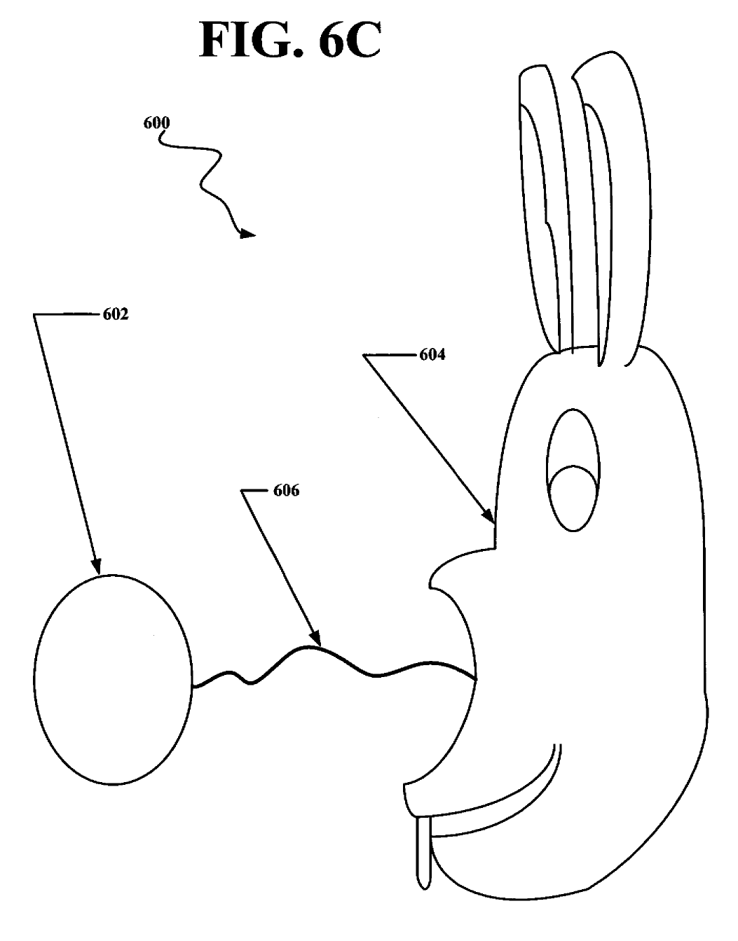

FIG. 6A is a front view and FIG. 6B is a side view of the throw device 600 in a retracted position, in accordance with a third exemplary embodiment of the invention. In accordance with the third embodiment, the throw device 600 is shaped to resemble the head of a rabbit. The throw object 602 is a ball and is made to resemble the tip of the nose of the rabbit. The handle 604 is shaped like the rest of the head of the rabbit. Similar to the throw device 100 described in the first embodiment, the user grasps the rabbit head-shaped handle 604 and twirls the throw object 602 in a circular manner. The momentum of the throw object 602 carries the rabbit head-shaped handle 604 through the air. The animal grasps the throw object 602 within its mouth and returns the throw device 600 to the user. A switch (not shown) and a cord retention device (not shown) can be incorporated with the throw device 600 of the third embodiment as described in the first embodiment of the throw device 100. FIG. 6C is a side view of the throw device 600 of FIG. 6A in an extended position, in accordance with the third exemplary embodiment of the invention.

The throw device 600 is not limited to being shaped as described herein. The throw device 600 can be shaped to resemble any character or article. For example, the throw device 600 can be shaped to resemble a cartoon cat with the head being the throw object 602 and the handle 604 being shaped to resemble the body of the cat. The throw device 600 can also be designed to resemble a clown, mailman, or other character. All variations on the shape of the throw device 600 are within the scope of the present inventions.

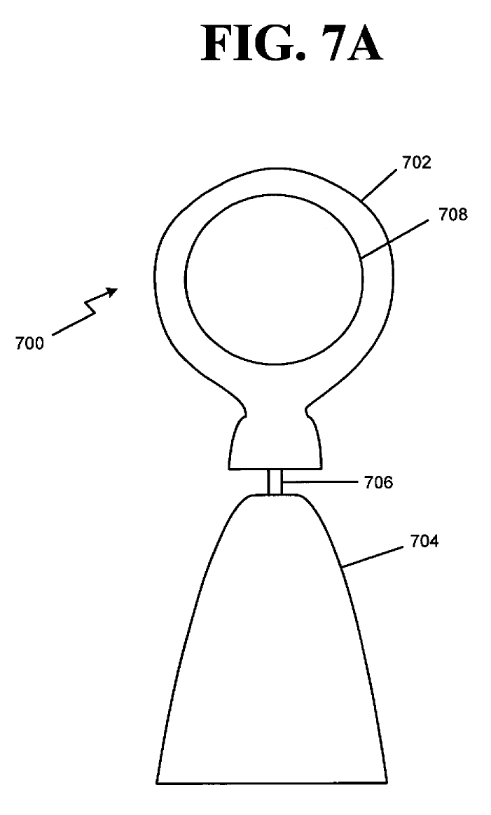

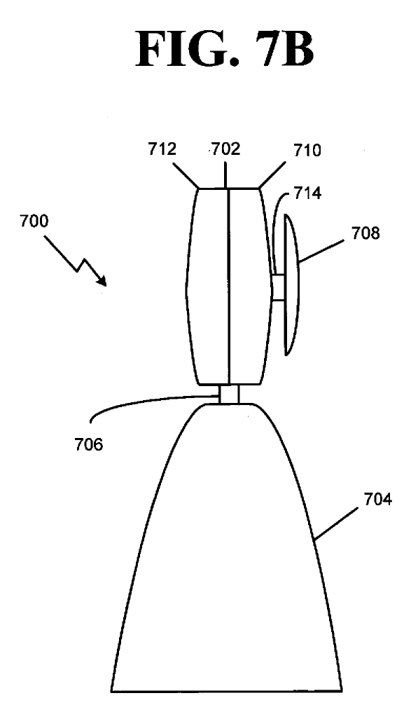

FIG. 7A is a front view of a throw device 700 in a retracted position, in accordance with a fourth exemplary embodiment of the invention. FIG. 7B is a side view of the throw device of FIG. 7A in a retracted position, in accordance with the fourth exemplary embodiment of the invention. A throw object 702 is shaped like a disk and may be made of plastic or a similarly rigid material. The throw object 702 may further be provided with a rubber-like outer coating or other similar coating as may be recognized as appropriate for chew toys in the animal husbandry industry. A handle 704 is shaped conically, although other shapes may be feasible and recognizable to those having ordinary skill in the art, including, but not limited to, a cylindrical shape molded into a traditional handle grip. The handle 704 may be attached to the throw object 702 by a cord 706, rope, or similar article. The user may be expected to grasp the handle 704 and twirl the throw object 702 in a circular manner. The momentum of the throw object 702 carries the dog head-shaped handle 704 through the air. The animal grasps the throw object 702 within its mouth and returns the throw device 700 to the user. A switch 708 and a cord retention device (not shown) can be incorporated with the throw object 702 of the fourth exemplary embodiment as will be further explained herein.

FIG. 7B is a side view of the throw device of FIG. 7A in a retracted position, in accordance with the fourth exemplary embodiment of the invention. As shown, the throw object 702 is attached to the handle 704 by the cord 706. The throw object 702 includes a front cover 710 and a back cover 712. The switch 708 is connected to the throw object 702 through the front cover 710 by a switch neck 714. The front cover 710 and back cover 714 may be joined mechanically by screws or other means known to those having ordinary skill in the art.

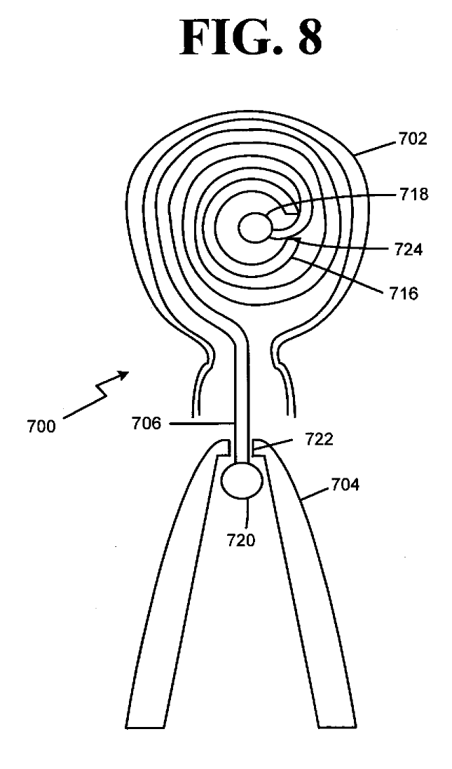

FIG. 8 is a front cross-sectional view of the throw device 700 of FIG. 7A, in accordance with the fourth exemplary embodiment of the invention. As shown, the throw object 702 is attached to the handle 704 by the cord 706. The cord 706 is wrapped about and connected to a reel 716 within the throw object 702. The cord 706 is connected to the reel 716 by passing through a reel slot 724 and concluding with a first knot 718 or similar termination that is larger than the reel slot 724, thereby securing the cord 706 within the throw object 702. An opposing end of the cord 706 passes through a handle opening 722 and is terminated with a second knot 720 or similar termination, thereby securing the cord 706 to the handle 704. The reel 716 is rotatably connected within the throw object 702, as will be explained further herein, such that pulling the throw object 702 from the handle 704 will cause the reel 716 to rotate and extend the cord 706.

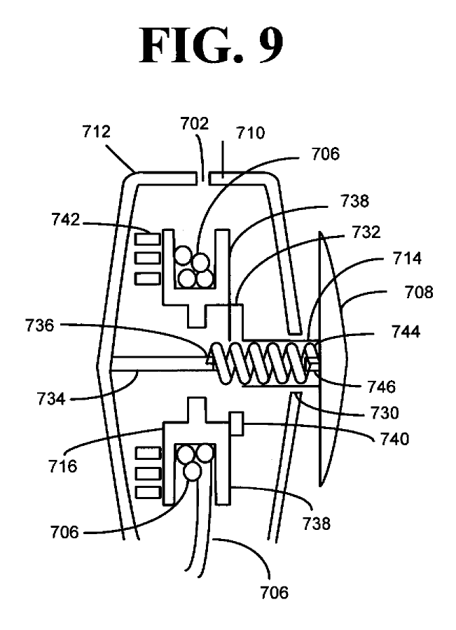

FIG. 9 is a side cross-sectional view of a portion of the throw device 700 of FIG. 7A, in accordance with the fourth exemplary embodiment of the invention. More specifically, FIG. 9 is a side cross-sectional view of the throw object 702. The throw object 702 includes the front cover 710 and the back cover 712. The switch 708 is connected to the throw object 702 through a cover opening 730 in the front cover 710 by the switch neck 714. The switch 708 is retained at least partially within the front cover 710 by switch tabs 732 that extend out from the switch neck 714. The reel 716 is supported within the throw object 702 at least partially by a reel support 734 attached to the back cover 712. The reel 716 has a reel opening 736 within which the reel support 734 rests. The reel 716 is freely rotatable relative to the reel support 734. The cord 706 is wrapped about the reel 716 and rests within the reel walls 738.

A coiled band 742 is provided. The coiled band 742 is connected (not shown) at one end to the reel support 734 and at the other end to a reel wall 738. The coiled band 742 biases the reel 716 to recoil the cord 706 when the cord 706 is uncoiled. The reel 716 is farther fitted with reel notches 740. The reel notches 740 are positioned to make to be obstructed by the switch tabs 732 such that the switch tabs 732 impede the rotation of the reel 716. The switch tabs 732 may be moved toward the reel 716 by pushing the switch 708 toward the throw object 702 such that the switch tabs 732 cannot obstruct the reel notches 740 and the rotation of the reel 716. The reel notches 740 may be curved on one side as may the switch tabs 732 such that when uncoiling the cord 706, the switch tabs 732 are moved toward the reel 716 by the reel notches 740, but when the reel 716 is coiling the cord 706, the switch tabs 732 impede rotation of the reel 716.

Operatively, this arrangement allows the cord 706 to be freely pulled from the throw object 702 a set length, which locks into place as the switch tabs 732 impede the reel notches 740 from allowing the coiled band 742 to recoil the cord 706. Then, when the switch 708 is pushed toward the throw object 702, the reel notches are freed from the switch tabs 732 and the coiled band 742 freely recoils the cord 706.

A spring 744 is provided to bias the switch 708 from being pushed toward the throw object 702 without a minimal exertion of force. The spring 744 may sit on a switch nub 746 and the reel support 734.

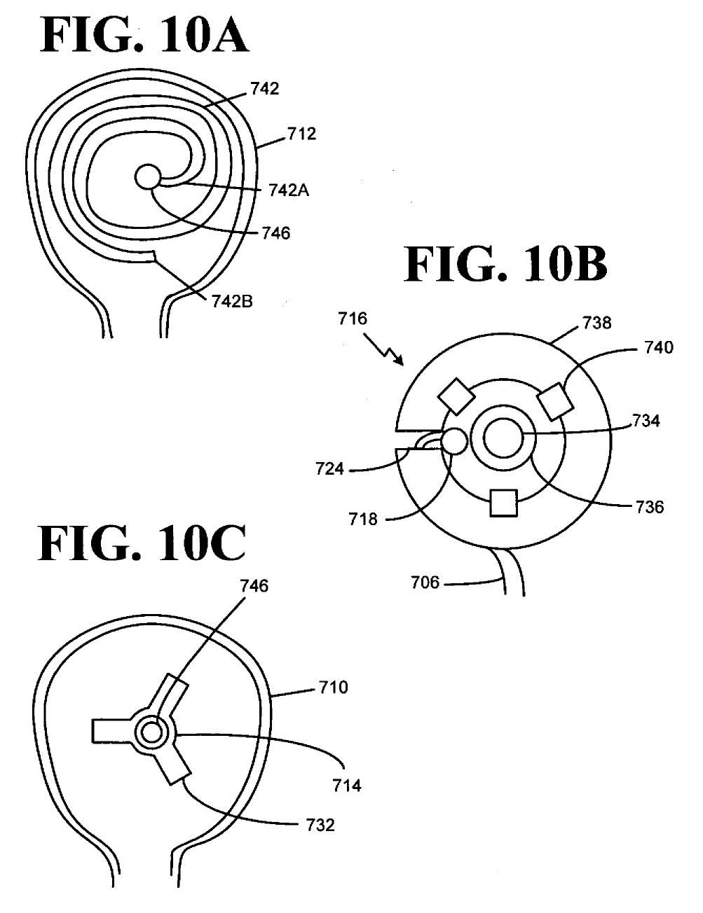

FIG. 10A is a front view of an interior portion of the throw device 700 of FIG. 7A, in accordance with the fourth exemplary embodiment of the invention. FIG. 10A shows an interior side of the back cover 712 with the reel support 734 mounted approximately in the center of the back cover 712. A first end 742A of the coiled band 742 is attached to the reel support 734. The first end 742A may be mechanically attached by a screw or by other means known to those having ordinary skill in the art. A second end 742B of the coiled band 742 is attached to the reel (not shown). The second end 742B may be mechanically attached to the reel, by means known to those having ordinary skill in the art.

FIG. 10B is an additional front view of an interior portion of the throw device 700 of FIG. 7A, in accordance with the fourth exemplary embodiment of the invention. More specifically, FIG. 10B shows a front view of the reel 716. The reel 716 includes the reel wall 738 and the reel opening 736. The reel notches 740 are attached the reel wall 738 and extend inwardly. The reel support 734 extends through the reel opening 736, allowing rotational movement of the reel 716 about the reel support 734. The reel slot 724 extends through the reel wall 738 allowing the cord 706 to extend therethrough. The reel slot 724 is sufficiently narrow to impede the passage of the first knot 718 through the reel slot 724.

FIG. 10C is a back view of an interior portion of the throw device 700 of FIG. 7A, in accordance with the fourth exemplary embodiment of the invention. More specifically, FIG. 10C is a back view of the front cover 710. The back view of the front cover 710 shows the switch neck 714 and the switch tabs 732 extending therefrom. FIG. 10B and FIG. 10C show three reel notches 740 and switch tabs 732, respectively. While the number of each may vary, preferably an equal number of reel notches 740 and switch tabs 732 are utilized and are equally spaced to allow all of the reel notches 740 and the switch tabs 732 to operate concurrently and cooperatively when restraining the reel 716 from recoiling. FIG. 10C also shows the switch nub 746 along which the spring 708 (shown in FIG. 9) may be located.

Other designs for allowing interaction between the switch 708 and the reel 716 may be devised by those having ordinary skill in the art without departing from the scope of the invention. The spring 744 may have sufficient tension to bias the switch 708 into a position that allows the reel notches 740 and the switch tabs 732 to operate cooperatively when restraining the reel 716 from recoiling. The spring 744 may also have tension sufficiently limited such that the throw object 702, when thrown, will recoil the cord 706 upon impacting the ground. More specifically, a quick jostling of the switch 708 or an indirect impact of the switch 708 with the ground may be sufficient to unalign the switch tabs 732 relative to the reel notches 740 and permit the reel 716 to recoil through biasing from the coiled band 742.

By putting the reel 716 and related mechanical elements of the invention in the throw object 702, the throw device 700 may have a throw object 702 that is heavier than the handle 704. This weight disparity may allow the throw device 700 to be thrown further when a user, holding the handle 704, twirls the throw object 702 about the handle 704 and then releases the handle 704. The throw object 702 may simply be more than 50% of the weight of the throw device 700. The throw object 702 may be at least 60% of the weight of the throw device 700. The throw object 702 may be at least 70% of the weight of the throw device 700.

It should be emphasized that the above-described embodiments of the present invention, particularly, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A throw device, comprising
a throw object;
a cord attached to the throw object
a handle coupled to the cord; and
a cord retention device comprising a switch to release the cord coupled between the throw object and the handle.

2. The throw device of claim 1, wherein the switch is capable of retaining the cord in a plurality of different lengths between the handle and the throw object.

3. The throw device of claim 1, wherein the switch is capable of retaining the cord in multiple positions.

4. The throw device of claim 1, further comprising a swiveling attachment mechanism connected between the handle and the cord.

5. The throw device of claim 1, wherein the cord is of adjustable length.

6. The throw device of claim 1, wherein the throw object weighs more than the handle.

7. The throw device of claim 1, wherein the cord retention device further comprises a spring-loaded spool lockable in at least two positions with the switch.

8. The throw device of claim 1, wherein the cord is retractable within the throw object.

9. The throw device of claim 1, wherein the switch is spring-loaded whereby releasing the switch unlocks a spring-loaded spool.

10. The throw device of claim 1, wherein the throw object and handle are formed to resemble a face.

11. A method of playing fetch with an animal, comprising the steps of:
extending a length of the cord between a throw object and a handle;
twirling the throw object around the handle;
releasing the handle;
allowing the centrifugal force to carry the throw object and handle through the air; and
retrieving the throw object and handle.

12. The method of claim 11, further comprising recoiling the length of the cord with a spring-loaded spool.

13. The method of claim 11, further comprising recoiling the length of the cord automatically after releasing the handle.

14. The method of claim 11, wherein the step of extending the length of the cord further comprises:
extending a partial length of the cord between the throw object and the handle, whereby the partial length of the cord is less than a full length of the cord; and
locking the partial length of the cord in place with a switch.

15. A system for playing fetch with a pet, the system comprising:
means for extending a length of the cord between a throw object and a handle;
means for generating centrifugal force on the throw object; and
means for throwing the throw object utilizing the centrifugal force.

16. The system of claim 15, wherein the means for extending a length of the cord further comprises means for extending a limited length of the cord.

17. The system of claim 15, further comprising means for retracting the length of the cord.

18. The system of claim 15, further comprising means for automatically initiating the means for retracting the length of the cord.

19. The system of claim 15, further comprising means for locking the length of the cord, thereby inhibiting the means for extending and the means for retracting the length of the cord.
